(19) United States
(12) Patent Application Publication
(10) Pub. No.: US 2011/0240927 A1
(43) Pub. Date: Oct. 6, 2011

(54) CONDUCTIVE POLYMER COMPOSITION AND CONDUCTIVE FILM FORMED USING THE SAME

(75) Inventors: Sang Hwa KIM, Gyunggi-do (KR); Young Soo OH, Gyunggi-do (KR); Jong Young LEE, Gyunggi-do (KR); Ho Joon PARK, Seoul (KR)

(73) Assignee: SAMSUNG ELECTRO-MECHANICS CO., LTD., Gyunggi-do (KR)

(21) Appl. No.: 13/081,249

(22) Filed: Apr. 6, 2011

Related U.S. Application Data
(63) Continuation-in-part of application No. 12/705,483, filed on Feb. 12, 2010.

(30) Foreign Application Priority Data
Dec. 23, 2009 (KR) 10-2009-0130153

(51) Int. Cl. H01B 1/12

(52) U.S. Cl. 252/500

(57) ABSTRACT

Disclosed herein is a conductive polymer composition, including: a conductive polymer; a liquid crystal polymer; and a solvent. The conductive polymer has excellent conductivity properties because it including a liquid crystal polymer which serves as a binder and has high molecular regularity.

Disclosed herein is a conductive film, including: a base member; and a transparent electrode formed on the base member by coating the base member with a conductive polymer composition including a conductive polymer, a liquid crystal polymer and a solvent and then drying the conductive polymer composition. The conductive film can be widely used in displays, touch panels and the like because it has excellent conductivity properties.

### CLAIM TO PRIORITY AND CROSS REFERENCE TO RELATED APPLICATION

This application is a Continuation-in-part of U.S. patent application Ser. No. 12/705,483, entitled, “Conductive polymer composition and conductive film prepared using the composition” filed Feb. 12, 2010, and claims the benefit of Korean Patent Application No. 10-2009-0130153, filed Dec. 23, 2009, entitled “Conductive polymer composition and conductive film prepared using the composition”, which is hereby incorporated by reference in its entirety into this application.

### BACKGROUND OF THE INVENTION

1. Technical Field

The present invention relates to a conductive polymer composition and a conductive film formed using the same.

2. Description of the Related Art

As various computers, electrical household appliances, and communication appliances are digitalized and rapidly highly-functionalized, it is keenly required to realize portable displays. In order to realize the portable displays, electrode materials for the portable displays must be transparent and have low resistance, must exhibit high flexibility so that the portable displays are mechanically stable, and must have a thermal expansion coefficient similar to that of a substrate not to overheat apparatuses and not to cause a short circuit or a great change in resistance even at high temperatures.

Currently, a transparent conductive oxide (TCO) electrode, such as an indium-tin oxide (ITO) electrode, an antimony-tin oxide (ATO) electrode or the like, is chiefly being used as an electrode for displays. This transparent conductive oxide (TCO) electrode is formed by sputtering, and its forming process is complicated and requires high cost. Particularly, the problems of the indium-tin oxide (ITO) electrode are as follows:

1. The ITO electrode is made of an inorganic material, and thus wide cracks may occur at the time of forming the same.

2. Indium, which is the main raw material of the ITO electrode and is a limited mineral resource, is being rapidly exhausted with the expansion of the market for flat display panels.

3. The ITO electrode is not easy to fabricate because its fabricating process is complicated and its characteristics are limited when it is applied to a film in order that it be used in a touch screen.

Owing to the above problems of the ITO electrode, research into its alternatives has been conducted in various ways. Among the alternatives, conductive polymers have lately attracted considerable attention because they are flexible and cheap. Examples of the conductive polymers may include polyaniline, polypyrrol, polythiophene, and the like. A polyethylenedioxythiophene/polystyrene sulfonate (PEDOT/PSS) complex, which is one of polythiophene derivatives, was developed by Bayer Corp. (brand name: Baytron P), and has been frequently used in antistatic films. However, the PEDOT/PSS complex has a surface resistance of about 10⁵˜10⁹Ω/□, and thus cannot suffice as an alternative to ITO. Further, it was proposed in many research papers that a solvent, such as dimethylsulfoxide (DMSO), ethylene glycol, sorbitol or the like, be added to ITO to improve the conductivity thereof. However, the addition of the solvent to the ITO is also insufficient as an alternative to ITO, and rather allows the conductivity of ITO to be further deteriorated by a binder which is inevitably used during a filming process. Other conductive polymers also have the above problems.

Korean Patent No. 06-92474 discloses a conductive polymer composition including polyethylenedioxythiophene (PEDOT), oxygen-containing organic compounds (excluding nitrogen-containing organic compounds), and the like. However, an adhesive polymer used to form a conductive layer is not disclosed and proposed in the Patent No. 06-92474.

Further, a transparent conductive film formed of the conductive polymer composition disclosed in Patent No. 06-92474 has a surface resistance of 10000Ω/□ or less, but this conductive polymer composition also does not suffice as an alternative to ITO.

Therefore, it is required to develop a conductive polymer having low surface resistance, which is suitable for use in transparent electrodes for displays, touch panels and the like.

### SUMMARY OF THE INVENTION

Accordingly, the present invention has been made to solve the above-mentioned problems, and the present invention intends to provide a conductive polymer composition which can exhibits excellent conductivity properties by adding a liquid crystal polymer and a conductive film formed using the same.

An aspect of the present invention provides a conductive polymer composition, including: a conductive polymer; a liquid crystal polymer; and a solvent.

Here, the conductive polymer composition may include 15˜70 wt % of a conductive polymer, 0.1˜20 wt % of a liquid crystal polymer, and 20˜75 wt % of a solvent.

Further, the liquid crystal polymer may be included in an amount of 5˜10 wt %.

Further, the liquid crystal polymer may be an acrylic liquid crystal polymer.

Further, the acrylic liquid crystal polymer may be 1,4-bis[3-(acryloyloxy)propyloxy]-2-methyl benzene.

Further, the acrylic liquid crystal polymer may be a mixture of 1,4-bis[3-(acryloyloxy)propyloxy]-2-methyl benzene and 1,6-hexanedioldiacrylate (HDDA), and the mixture may have a mixing ratio of 1:1˜5:1.

Further, the conductive polymer may be poly-3,4-ethylenedioxythiophene/polystyrene sulfonate (PEDOT/PSS).

Further, the solvent may be any one selected from among aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, water, and mixtures thereof.

The conductive polymer composition may further include at least one additive selected from the group consisting of a secondary dopant, a dispersion stabilizer and a binder.

The secondary dopant may be at least one polar solvent selected from the group consisting of dimethylsulfoxide, N-methylpyrrolidone, N,N-dimethylformamide, and N-dimethylacetimide.

The dispersion stabilizer may be ethylene glycol or sorbitol.

Another aspect of the present invention provides a conductive film, including: a base member; and a transparent electrode formed on the base member by coating the base member with a conductive polymer composition including a conductive polymer, a liquid crystal polymer and a solvent and then drying the conductive polymer composition.

Here, the liquid crystal polymer may be an acrylic liquid crystal polymer.

Further, the acrylic liquid crystal polymer is may be 1,4-bis[3-(acryloyloxy)propyloxy]-2-methyl benzene.

Further, the acrylic liquid crystal polymer may be a mixture of 1,4-bis[3-(acryloyloxy)propyloxy]-2-methyl benzene and 1,6-hexanedioldiacrylate (HDDA), and the mixture may have a mixing ratio of 1:1˜5:1.

Further, the conductive polymer may be poly-3,4-ethylenedioxythiophene/polystyrene sulfonate (PEDOT/PSS).

Further, the conductive polymer composition may further include a secondary dopant.

Further, the secondary dopant may be at least one polar solvent selected from the group consisting of dimethylsulfoxide, N-methylpyrrolidone, N,N-dimethylformamide, and N-dimethylacetimide.

Further, the transparent electrode may have a surface resistance of 10˜1000Ω/□.

The objects, features and advantages of the present invention will be more clearly understood from the following detailed description.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWING

The above and other objects, features and advantages of the present invention will be more clearly understood from the following detailed description taken in conjunction with the accompanying drawing, in which:

FIG. 1 is a sectional view showing a conductive film according to an embodiment of the present invention.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the attached drawing.

A conductive polymer composition according to an embodiment of the present invention includes a conductive polymer, a liquid crystal polymer, and a solvent. The conductive polymer composition is characterized in that it serves as a binder and includes a liquid crystal polymer providing the improvement of conductivity properties.

The liquid crystal polymer is a compound exhibiting both liquid crystallinity and polymeric properties. A liquid crystal phase, which is an intermediate phase between a solid phase and a liquid phase, differently from the solid phase, has an orientational order although it does not have a positional order, so that it exhibits intrinsic properties. Further, the liquid crystal phase is different from the liquid phase which has neither positional order nor orientational order.

Generally, a polar solvent, referred to as a secondary dopant, is used to improve the conductivity of the conductive polymer, but, even in this case, the conductivity of the conductive polymer can be improved only to such a degree that the surface resistance of the conductive polymer reaches 1000Ω/□. Further, a binder is inevitably used as a adhesive in order to improve the adhesivity between the conductive polymer composition and a base member. However, when this binder is used, the conductivity properties of the conductive polymer unavoidably deteriorate.

However, as in the present invention, when the liquid crystal polymer is added, the binder may not be used or can be used at minimum, thus preventing the deterioration of the conductivity properties of the conductive polymer.

As described above, since the liquid crystal polymer has an orientational order as an intrinsic property, the liquid crystal polymer influences the form and arrangement of the conductive polymer when it is mixed with the conductive polymer composition after which such conductive polymer composition is applied. Therefore, due to the high order of the liquid crystal polymer, the order of the conductive polymer is also increased, and simultaneously the conductivity of a film formed using this conductive polymer composition can be rapidly increased.

In this case, the liquid crystal polymer may be an acrylic liquid crystal polymer. The acrylic liquid crystal polymer is advantageous in that it is cheap, and is easily polymer-polymerized. For example, 1,4-bis[3-(acryloyloxy)propyloxy]-2-methyl benzene (RM257 or RM82, manufactured by Merck Corp.) may be used as the liquid crystal polymer.

Further, the liquid crystal polymer may be a mixture of isotropic monomers, such as 1,4-bis[3-(acryloyloxy)propyloxy]-2-methyl benzene, 1,6-hexanedioldiacrylate (HDDA) and the like. When 1,6-hexanedioldiacrylate (HDDA) is added, there is an advantage in that the workability of the conductive polymer composition is improved. Considering the conductivity properties of the conductive polymer composition, the mixing ratio of 1,4-bis[3-(acryloyloxy)propyloxy]-2-methyl benzene and 1,6-hexanedioldiacrylate (HDDA) may be 1:1˜5:1.

However, the liquid crystal polymer of the present invention is not limited to the above-mentioned acrylic liquid crystal polymer, and may be used in a polymer or monomer form.

The liquid crystal polymer may be included in an amount of 0.1˜20 wt %, preferably 5˜10 wt %, based on the total amount of the conductive polymer composition. When the amount of the liquid crystal polymer is less than 0.1 wt %, the effects of improving the conductivity and adhesivity attributable to the use of the liquid crystal polymer are slight. In contrast, when the amount thereof is more than 20 wt %, the amount of the conductive polymer and the amount of the polar solvent are not relatively sufficient, thus deteriorating conductive properties.

The conductive polymer composition of the present invention may be used after directly adding the liquid crystal polymer thereto, and may be used after it has been applied to a base member.

Generally, a conductive polymer, which is a polymer having one π-electron per one carbon atom and having electrical conductivity, has a molecular weight of about 10,000 or more. A conductive polymer is advantageous in that it is light compared to conventional indium tin oxide (ITO) and in that thin film having high flexibility can be obtained. Such a conductive polymer may be any one selected from polythiophene-based, polypyrrole-based, polyphenylene-based, polyaniline-based and polyacetylene-based conductive polymers.

In this case, the polythiophene-based conductive polymer may be polyethylenedioxythiophene/polystyrene sulfonate (PEDOT/PSS). Concretely, Clevios P, manufactured by H.C Stalc Corporation, is used as the polythiophene-based conductive polymer. The polyethylenedioxythiophene (PEDOT), which is a primary dopant, is easily dissolved in the water containing polystyrene sulfonate (PSS), and has very excellent thermal stability.

The conductive polymer is included in an amount of 15˜70 wt %, preferably, 25˜65 wt %. When the amount of the conductive polymer is less than 15 wt %, it is difficult to realize a conductivity of 1 kΩ/m² even when a polar solvent is additionally used as a dopant. When the amount thereof is more than 70 wt %, coating workability is not easy.

The solvent, which is used as a dispersant of the conductive polymer composition of the present invention, may be any one selected from among aliphatic alcohols, such as methanol, ethanol, i-propanol, butanol and the like; aliphatic ketones, such as acetone, methylethyl ketone and the like; aliphatic carboxylic acid esters; aliphatic carboxylic acid amides; aromatic hydrocarbons; aliphatic hydrocarbons; acetonitrile, aliphatic sulfoxides; water; and mixtures thereof.

The solvent is included in the conductive polymer composition in an amount of 20˜75 wt %, preferably, 25˜70 wt %. When the amount of the solvent is less than 20 wt %, the dispersibility of the conductive polymer in a solution decreases. When the amount thereof is more than 75 wt %, the conductivity of the conductive polymer composition decreases.

Here, the conductive polymer composition may further include at least one additive to selected from the group consisting of a secondary dopant, a dispersion stabilizer and a binder.

The secondary dopant is a polar solvent, and is added to the conductive polymer composition in order to improve conductivity properties. The secondary dopant may be at least one polar solvent selected from the group consisting of dimethylsulfoxide, N-methylpyrrolidone, N,N-dimethylformamide, and N-dimethylacetimide. The secondary dopant is included in an amount of 0.5˜5 wt %, preferably, 1.5˜4 wt %. When the amount of the secondary dopant is less than 0.5 wt %, the effect of improving electrical conductivity is slight, and, when the amount thereof is more than 5 wt %, the effect of improving electrical conductivity caused by the addition of the secondary dopant does not occur, so that the secondary dopant can be squandered.

Further, the conductive polymer composition of the present invention may further include a dispersion stabilizer. Ethylene glycol, sorbitol or the like may be used as the dispersion stabilizer. When the secondary dopant, as a polar solvent, is used together with the dispersion stabilizer, the effect of improving electrical conductivity become high compared to when only the secondary dopant is used. The dispersion stabilizer is included in an amount of 0.5˜7 wt %, preferably, 1˜5 wt %.

Further, the conductive polymer composition of the present invention may further include a binder. The binder is used to increase the adhesivity between a base member and the conductive polymer composition. Examples of the binder may include an acrylic binder, an epoxy binder, a urethane binder, an ether binder, a carboxylic binder, an amide binder and the like, and can be easily selected according to the kind of a base member that is used.

Furthermore, the conductive polymer composition of the present invention may further include a surfactant, an anti-foamer or the like.

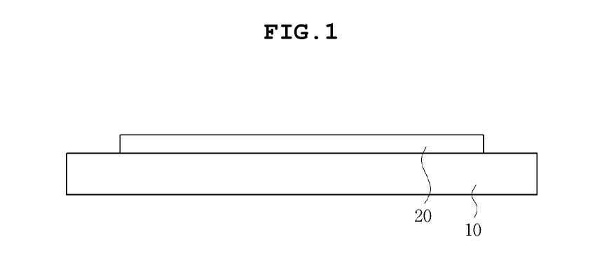

A conductive film according to another embodiment of the present invention, as shown in FIG. 1, includes a base member 10; and a transparent electrode 20 formed on the base member 10 by coating the base member with a conductive polymer composition including a conductive polymer, a liquid crystal polymer and a solvent and then drying the conductive polymer composition. Hereinafter, the conductive film will be described according to its constituents. The description thereof overlapping the above description will be omitted or briefly mentioned.

As shown in FIG. 1, the transparent film 20 is formed on the base member 10, and has excellent conductivity properties because it includes a liquid crystal polymer. Here, since the liquid crystal polymer functions as a binder, a binder is not additionally used or is minimally used, thus preventing the conductivity of the transparent electrode from deteriorating.

In this case, the liquid crystal polymer may be an acrylic liquid crystal polymer. For example, 1,4-bis[3-(acryloyloxy)propyloxy]-2-methyl benzene (RM257 or RM82, manufactured by Merck Corp.) may be used as the liquid crystal polymer.

Further, the liquid crystal polymer may be a mixture of isotropic monomers, such as 1,4-bis[3-(acryloyloxy)propyloxy]-2-methyl benzene, 1,6-hexanedioldiacrylate (HDDA) and the like.

Further, the conductive film of the present invention may be formed using the conductive polymer composition further including a secondary dopant. The secondary dopant is added to the conductive polymer composition in order to further improve the conductivity of the transparent electrode 20. The secondary dopant may be at least one polar solvent selected from the group consisting of dimethylsulfoxide, N-methylpyrrolidone, N,N-dimethylformamide, and N-dimethylacetimide.

The conductive film 20 of the present invention may have a surface resistance of 10˜1000Ω/□. Thus, since the conductive film 20 exhibits conductivity properties, it can be used in displays, touch panels and the like as an alternative material of ITO.

The base member 10, onto which the conductive polymer composition of the present invention is applied, may be made of any one selected from among glass, reinforced glass, polyethylene terephthalate (PET), polyethylenenaphthalene dicarboxylate (PEN), polycarbonate (PC), polymethylmethacrylate (PMMA), ring-shaped olefin polymers (COC), and blends thereof.

Further, the base member 10 may have a thickness of 10˜1500 μm. When the thickness of the transparent substrate is excessively thin, the transparent substrate cannot serve as a support. In contrast, when the thickness thereof is excessively thick, there is a problem in that it is difficult to make displays, touch panels and the like small.

The conductive polymer composition may be applied on the base member 10 by spin coating, bar coating, spray coating, ink-jet printing, spreading, dipping or the like.

Further, the adhesivity of the conductive polymer composition can be improved by irradiating the base member 10 with UV (ultraviolet), corona-treating the transparent substrate, or primer-treating the transparent substrate.

### Examples 1 to 5

A conductive polymer composition was prepared by the components and its contents (wt %) given in Table 1 below.

Additives were mixed with an aqueous PEDOT/PSS solution as a conductive polymer, and then stirred for about 1 hour to prepare a conductive polymer composition. The prepared conductive polymer composition was applied onto a transparent substrate, and then dried at a temperature of 80˜100 for 5 minutes to form a conductive polymer thin film. The formed conductive polymer thin film had a thickness of 100˜200 nm and exhibited a transmissivity of 80% or more. 1,4-bis[3-(acryloyloxy)propyloxy]-2-methyl benzene (RM257 or RM82, manufactured by Merck Corp.) was used as the liquid crystal polymer.

TABLE 1
(unit: wt %)

| | | | | |
|---|---|---|---|---|
| Aqueous | | | | Liquid |
| PEDOT | | | | crystal |
| solution | Solvent | Dopant | Binder | polymer |

| | | | | | |
|---|---|---|---|---|---|
| Example 1 | 28 | i-propanol 64 | DMSO 1 | acryl 5 | 2 |
| Example 2 | 28 | i-propanol 64 | DMSO 1 | PVA 5 | 2 |
| Example 3 | 28 | i-propanol 64 | DMSO 1 | — | 7 |
| Example 4 | 28 | ethanol 64 | DMSO 1 | acryl 5 | 2 |
| Example 5 | 28 | ethanol 64 | DMSO 1 | acryl 5 | 2 |

### Comparative Examples 1 and 2

Conductive films were obtained using the same method as in Examples 1 to 5, except that the conductive polymer compositions given in Table 2 below were used.

In Comparative Example 1, the conductive polymer composition, differently from the conductive polymer composition of the present invention, does not include a liquid crystal polymer. In Comparative Example 2, the conductive polymer composition includes 24 wt % of a liquid crystal polymer, which deviates from the preferred range of adding the liquid crystal polymer of the present invention which is 0.1˜20 wt %.

TABLE 2
(unit: wt %)

| | Aqueous | | | | Liquid |
|---|---|---|---|---|---|
| | PEDOT | | | | crystal |
| | solution | Solvent | Dopant | Binder | polymer |
| Comp. Exp. | 28 | i-propanol 66 | DMSO 1 | acryl 5 | — |
| 1 | | | | | |
| Comp. Exp. | 28 | i-propanol 42 | DMSO 1 | acryl 5 | 24 |
| 2 | | | | | |

The surface resistance values of the conductive films according to Examples 1 to 5 and Comparative Examples 1 and 2 are given in Table 3 below.

TABLE 3

| | Surface resistance (Ω/□) | Adhesivity |
|---|---|---|
| Example 1 | 70 | good |
| Example 2 | 100 | good |
| Example 3 | 10 | good |
| Example 4 | 500 | good |
| Example 5 | 150 | good |
| Comp. Exp. 1 | 10,000 | good |
| Comp. Exp. 2 | 2,000 | good |

As given in Table 3, it can be seen that all of the conductive polymer films formed using the conductive polymer composition have a low surface resistance of 10˜1000Ω/□.

However, as in Comparative Example 1, when the liquid crystal polymer was not added, it can be seen that the conductive polymer film formed using the conductive polymer composition has a surface resistance of 10000Ω/□. Therefore, the conductive polymer composition according to Comparative Example 1 is not suitable as an alternative to ITO.

Further, as in Comparative Example 2, when the liquid crystal polymer was excessively added in an amount of more than 20 parts by weight, it can be seen that the conductive polymer film formed using the conductive polymer composition has a surface resistance of 2000Ω/□. Further, it can be seen that the conductive polymer composition according to Comparative Example 2 has a relatively high surface resistance compared to the conductive polymer composition according to the present invention. Therefore, it can be seen that the conductive polymer composition according to the present invention is more suitable to be used in electrodes for displays as an alternative of ITO.

As described above, since the conductive polymer composition and the conductive film according to the present invention include a liquid crystal polymer, the conductivity thereof is improved due to high molecular regularity of the liquid crystal polymer.

Further, the liquid crystal polymer can improve conductivity properties by using a minimum of binder or without using any binder at all because it also functions as a binder.

Further, the liquid crystal polymer is an acrylic liquid crystal polymer, and can be easily polymer-polymerized.

Further, the conductive film formed using the conductive polymer composition according to the present invention can be used in electrodes for various display devices, such as liquid crystal displays (LCDs), transparent touch panels, c-papers, organic light emitting diodes (OLEDs) and the like, because it has a low surface resistance of 10˜1000Ω/□.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A conductive polymer composition, comprising:
a conductive polymer;
a liquid crystal polymer; and
a solvent.

2. The conductive polymer composition according to claim 1, wherein the conductive polymer composition comprises 15˜70 wt % of a conductive polymer, 0.1˜20 wt % of a liquid crystal polymer, and 20˜75 wt % of a solvent.

3. The conductive polymer composition according to claim 2, wherein the liquid crystal polymer is included in an amount of 5˜10 wt %.

4. The conductive polymer composition according to claim 1, wherein the liquid crystal polymer is an acrylic liquid crystal polymer.

5. The conductive polymer composition according to claim 4, wherein the acrylic liquid crystal polymer is 1,4-bis[3-(acryloyloxy)propyloxy]-2-methyl benzene.

6. The conductive polymer composition according to claim 4, wherein the acrylic liquid crystal polymer is a mixture of 1,4-bis[3-(acryloyloxy)propyloxy]-2-methyl benzene and 1,6-hexanedioldiacrylate (HDDA), and the mixture has a mixing ratio of 1:1˜5:1.

7. The conductive polymer composition according to claim 1, wherein the conductive polymer is poly-3,4-ethylenedioxythiophene/polystyrene sulfonate (PEDOT/PSS).

8. The conductive polymer composition according to claim 1, wherein the solvent is any one selected from among aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, water, and mixtures thereof.

9. The conductive polymer composition according to claim 1, further comprising at least one additive selected from the group consisting of a secondary dopant, a dispersion stabilizer and a binder.

10. The conductive polymer composition according to claim 9, wherein the secondary dopant is at least one polar solvent selected from the group consisting of dimethylsulfoxide, N-methylpyrrolidone, N,N-dimethylformamide, and N-dimethylacetimide.

11. The conductive polymer composition according to claim 9, wherein the dispersion stabilizer is ethylene glycol or sorbitol.

12. A conductive film, comprising:
a base member; and
a transparent electrode formed on the base member by coating the base member with a conductive polymer composition including a conductive polymer, a liquid crystal polymer and a solvent and then drying the conductive polymer composition.

13. The conductive film according to claim 12, wherein the liquid crystal polymer is an acrylic liquid crystal polymer.

14. The conductive film according to claim 13, wherein the acrylic liquid crystal polymer is 1,4-bis[3-(acryloyloxy)propyloxy]-2-methyl benzene.

15. The conductive film according to claim 13, wherein the acrylic liquid crystal polymer is a mixture of 1,4-bis[3-(acryloyloxy)propyloxy]-2-methyl benzene and 1,6-hexanedioldiacrylate (HDDA), and the mixture has a mixing ratio of 1:1˜5:1.

16. The conductive film according to claim 12, wherein the conductive polymer is poly-3,4-ethylenedioxythiophene/polystyrene sulfonate (PEDOT/PSS).

17. The conductive film according to claim 12, wherein the conductive polymer composition further comprises a secondary dopant.

18. The conductive film according to claim 17, wherein the secondary dopant is at least one polar solvent selected from the group consisting of dimethylsulfoxide, N-methylpyrrolidone, N,N-dimethylformamide, and N-dimethylacetimide.

19. The conductive film according to claim 12, wherein the transparent electrode has a surface resistance of 10˜1000Ω/□.
